(19) United States
(12) Patent Application Publication
(10) Pub. No.: US 2011/0285494 A1
(43) Pub. Date: Nov. 24, 2011

(54) MULTILAYER TYPE INDUCTOR

(75) Inventors: Dong Jin JEONG, Busan (KR); Sung Jin PARK, Gimhae (KR); Jin Ho KU, Busan (KR); Min Sung CHOI, Jinhae (KR); Sin Gon Kim, Busan (KR); Yong Un CHOI, Busan (KR)

(73) Assignee: SAMSUNG ELECTRO-MECHANICS CO., LTD.

(21) Appl. No.: 13/114,385

(22) Filed: May 24, 2011

(30) Foreign Application Priority Data
May 24, 2010 (KR) 10-2010-0048069
May 24, 2010 (KR) 10-2010-0048070

(51) Int. Cl. H01F 5/00

(52) U.S. Cl. 336/200

(57) ABSTRACT

A multilayer type inductor includes: an inductor main body formed by laminating a plurality of sheets; a coil part including conductive patterns and conductive vias formed on the respective sheets; a first withdrawal via formed at one end of the coil part and withdrawn to one surface of the inductor main body through the inductor main body; a second withdrawal via formed at the other end of the coil part and withdrawn in the same direction as that of the first withdrawal via; and first and second external terminals formed on one surface of the inductor main body and electrically connected to the first and second withdrawal vias.

### CROSS-REFERENCE TO RELATED APPLICATIONS

This application claims the priority of Korean Patent Application Nos. 10-2010-0048069 filed on May 24, 2010 and 10-2010-0048070 filed on May 24, 2010, in the Korean Intellectual Property Office, the disclosures of which are incorporated herein by reference.

### BACKGROUND OF THE INVENTION

1. Field of the Invention

The present invention relates to a multilayer type inductor and, more particularly, to a multilayer type inductor having excellent electrical characteristics.

2. Description of the Related Art

An inductor, one of a number of important passive elements constituting an electric circuit, along with a resistor and a capacitor, is used as a component for canceling noise or constituting an LCD resonance circuit. The inductor may be fabricated by winding or printing a coil on a ferrite core and forming electrodes at both ends thereof, or may be fabricated by printing internal electrodes on a magnetic body or a dielectric body and laminating it.

Inductors may be classified into various types: a multilayer type inductor, a winding type inductor, a thin film type inductor, and the like. Among them, the multilayer type inductor tends to be in widespread use. The multilayer type inductor is fabricated by laminating a plurality of ceramic sheets (made of ferrite or of a dielectric material having a low dielectric constant). A metal pattern in a coil form is formed on each of the ceramic sheets. The metal patterns in the coil form formed on the respective ceramic sheets are sequentially connected by conductive vias formed on the respective ceramic sheets and overlap one another along a lamination direction to form a spiral coil. Both ends of the coil are withdrawn from the laminated body so as to be connected to an external terminal.

The metal patterns formed on each of the ceramic sheets may be formed through a printing method such as screen printing, or the like. A conductive material used to form the metal pattern is generally in a conductive paste state including an organic solvent, and the like.

The multilayer type inductor may be fabricated as a separate component in the form of a chip, or may be formed to be installed together with other modules in a substrate.

Recently, in order to fabricate a multilayer type inductor, a ceramic sheet to be fired at a low temperature is laminated, on which a printed electrode pattern is simultaneously fired at a temperature of 800° C. to 900° C. by using a low temperature cofired ceramic (LTCC) technique. After the laminated body is fired, an external terminal is formed to thus fabricate a multilayer type inductor. The fabricated multilayer type inductor must conform to an inductance value and an electric resistance value determined by the specifications of products. Also, the size of the multilayer type inductor must satisfy the determined specifications of products. Thus, the area occupied by the external terminal causes the internal area of the inductor to be reduced.

### SUMMARY OF THE INVENTION

An aspect of the present invention provides a multilayer type inductor having good electrical characteristics.

According to an aspect of the present invention, there is provided a multilayer type inductor including: an inductor main body 10 including a plurality of sheets laminated therein; a coil part including conductive patterns and conductive vias formed on the respective sheets; a first withdrawal via (or a first lead-out via) formed at one end of the coil part and withdrawn (or led out) to one surface of the inductor main body through the inductor main body; a second withdrawal via formed at the other end of the coil part and withdrawn in the same direction as that of the first withdrawal via; and first and second external terminals formed on one surface of the inductor main body and electrically connected to the first and second withdrawal vias.

The first withdrawal via may be formed at an inner side of the coil part.

The first withdrawal via may be formed at an outer side of the coil part.

The plurality of sheets may include a magnetic body.

The plurality of sheets may include a dielectric body.

The first and second withdrawal vias may be withdrawn in a winding direction of the coil part.

The first and second withdrawal vias may be withdrawn in a direction perpendicular to the winding direction of the coil part.

The first and second withdrawal vias may be withdrawn in mutually diagonal directions with respect to one surface of the inductor main body.

The first and second withdrawal vias may be withdrawn in mutually linear directions with respect to one surface of the inductor main body.

The first withdrawal via may be electrically connected to the first external terminal by a bridge electrode.

The conductive via and the first and second withdrawal vias include silver (Ag), silver-palladium (Ag—Pd), nickel (Ni), or copper (Cu).

### BRIEF DESCRIPTION OF THE DRAWINGS

The above and other aspects, features and other advantages of the present invention will be more clearly understood from the following detailed description taken in conjunction with the accompanying drawings, in which:

FIGS. 1a and 1b are schematic perspective view and sectional view of a multilayer type inductor according to an exemplary embodiment of the present invention;

FIG. 2 is an exploded perspective view of the multilayer type inductor illustrated in FIGS. 1a and 1b;

FIGS. 3a and 3b are schematic perspective view and sectional view of a multilayer type inductor according to another exemplary embodiment of the present invention;

FIG. 4 is an exploded perspective view of the multilayer type inductor illustrated in FIGS. 3a and 3b;

FIGS. 5a and 5b are schematic perspective view and sectional view of a multilayer type inductor according to another exemplary embodiment of the present invention; and

FIG. 6 is an exploded perspective view of the multilayer type inductor illustrated in FIGS. 5a and 5b.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

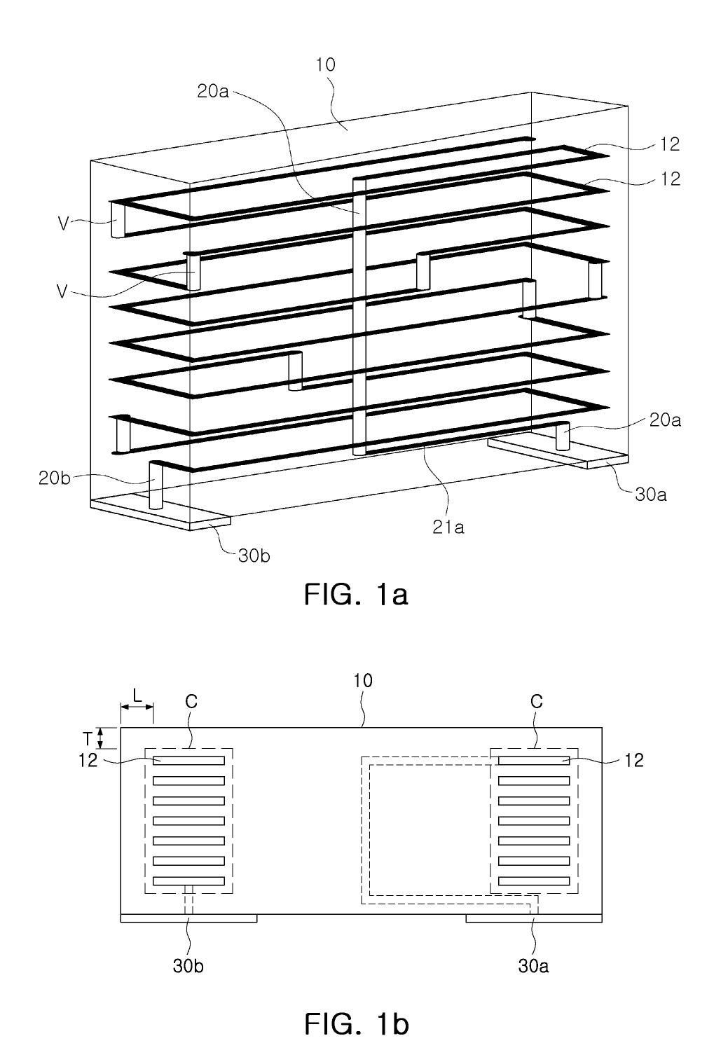

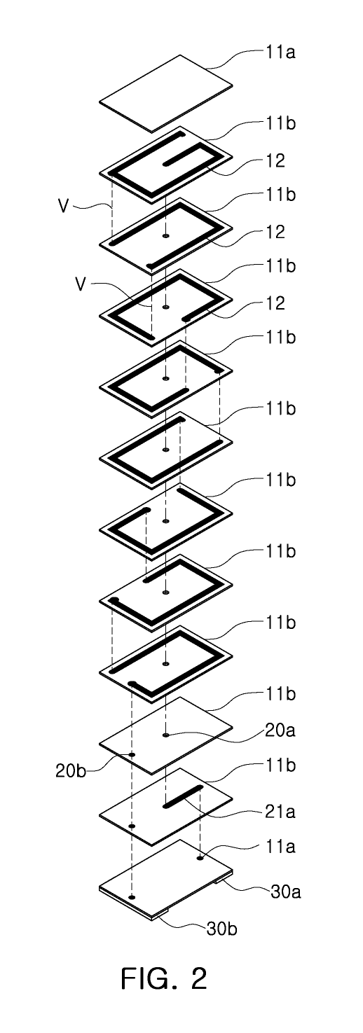

FIGS. 1a and 1b are schematic perspective view and sectional view of a multilayer type inductor according to an exemplary embodiment of the present invention, and FIG. 2 is an exploded perspective view of the multilayer type inductor illustrated in FIGS. 1a and 1b.

With reference to FIGS. 1a and 1b, a multilayer type inductor according to an exemplary embodiment of the present invention includes an inductor main body 10 including a plurality of sheets laminated therein, and first and second external terminals 30a and 30b formed on one surface of the inductor main body 10.

As shown in FIG. 2, the inductor main body 10 is formed by laminating a plurality of sheets 11a and 11b. Cover sheets 11a formed at the outermost part of the upper and lower surfaces of the inductor main body 10 do not have a conductive pattern 12 forming a coil part (C). The cover sheets 11a may be configured as a plurality of sheets according to thickness as necessary.

The respective sheets 11a and 11b may be made of a slurry phase composition prepared by mixing raw materials such as magnetic powder or dielectric powder such as ferrite powder, a binder, a plasticizer, and the like, and crushing the same with a ball mill.

The conductive pattern 12 is formed on one surface of each of the sheets 11b, rather than on the cover sheets 11a, and conductive vias (V) are formed such that they penetrate in a thicknesswise direction. One end of the conductive pattern 12 formed on each sheet is in contact with the conductive via (V) formed on an adjacent sheet.

The conductive patterns 12 formed on the respective sheets are connected by the conductive via (V) to form the winding coil part (C).

The number of sheets 11b forming the coil part (C) may be determined according to electrical characteristics such as inductance, or the like, required by the multilayer type inductor.

Both ends of the coil part (C) are withdrawn (or led out) to the exterior by first and second withdrawal vias (or first and second lead-out vias) 20a and 20b so as to be electrically connected to first and second external terminals 30a and 30b.

The first withdrawal via 20a formed at one end of the coil part (C) is formed to pass through the inductor main body 10. The first withdrawal via 20 is withdrawn from one end of the coil part (C), passing through the inductor main body 10, and then to one surface of the inductor main body 10.

The first withdrawal via 20a may be formed at an inner side of the coil part (C). Thus, the first withdrawal via 20a may be formed without altering the structure or internal area of the conductive pattern 12 constituting the coil part (C).

The second withdrawal via 20b formed at the other end of the coil part (C), is withdrawn in the same direction as that of the first withdrawal via 20a. Accordingly, the first and second external terminals 30a and 30b can be formed on the same plane of the inductor main body 10 and electrically connected to the first and second withdrawal vias 20a and 20b.

The first withdrawal via 20a may be electrically connected to the first external terminal 30a by a bridge electrode 21a. The bridge electrode 21a serves to adjust a withdrawal position of the first withdrawal via 20a withdrawn to one surface of the inductor main body 10, and thus, the position of the first external electrode 30a can be adjusted.

The conductive pattern 12 may be formed through methods such as thick film printing, coating, deposition, sputtering, and the like. Also, the conductive via (V) and the first and second withdrawal vias 20a and 20b may be formed by forming through holes on the sheets and charging conductive paste or the like in the through holes. The conductive paste may include metals such as silver (Ag), silver-palladium (Ag—Pd), nickel (Ni), copper (Cu), and the like.

The first external terminals 30a and 30b are formed on one surface of the inductor main body 10. Hereinafter, the one surface of the inductor main body 10 on which the first and second external terminals 30a and 30b are formed will be referred to as a ‘lower surface’.

The first and second external terminals 30a and 30b may be formed by using a method of soaking (or immersing) the inductor main body 10 in conductive paste, a printing method, deposition, sputtering, and the like. The conductive paste may include metals such as silver (Ag), silver-palladium (Ag—Pd), nickel (Ni), copper (Cu), and the like. Also, a nickel (Ni)-plated layer and a tin (Sn)-plated layer may be formed on the surface of the first and second external terminals.

In the related art, the multilayer type inductor is fabricated to have a structure in which external terminals are formed on lower, upper, and side surfaces of the inductor main body. Conductive patterns forming the coil part are withdrawn to both side surfaces of the inductor main body, and the external terminals are formed on the both side surfaces and on the upper and lower surfaces of the inductor main body so as to be connected with the withdrawn conductive patterns.

However, as for the multilayer type inductor according to the present exemplary embodiment, the external terminals 30a and 30b are formed on only one surface of the inductor main body. When the multilayer type inductor is fabricated according to a standard size, the multilayer type inductor according to the present exemplary embodiment is fabricated such that the area occupied by the external terminals is reduced and the area occupied by the inductor main body is increased, compared with the related art multilayer type inductor.

In the multilayer type inductor according to the present exemplary embodiment, because no external terminals are formed on the upper surface of the inductor main body, the thickness (T) of the cover layer can be increased. Thus, DC overlap characteristics can be reduced. Also, because no external terminals are formed on the side surfaces of the inductor main body, the thickness (L) of the side of the inductor main body can be secured and the internal area of the coil part can be increased to increase an inductance value.

Also, surface mounting can be easily performed by the first and second external terminals formed on the same plane of the inductor main body.

In the multilayer type inductor according to the present exemplary embodiment, the external terminals are formed only on one surface of the inductor main body, and the structure of the withdrawal vias formed at both ends of the coil part (C) is improved such that they are electrically connected with the external terminals. Namely, the first and second withdrawal vias are not particularly limited so long as they are withdrawn to the same plane of the inductor main body.

In the present exemplary embodiment, the first and second withdrawal vias 20a and 20b are withdrawn in the winding direction of the coil part (C).

However, the present invention is not limited thereto and the first and second withdrawal vias 20a and 20b are withdrawn in a direction perpendicular to the winding direction of the coil part (C). In this case, the withdrawal direction of the first and second withdrawal vias may be changed by the bridge electrode. The first and second withdrawal vias and the first and second external terminals may be formed on the side surfaces of the inductor main body, and in this case, the side surfaces of the inductor main body may serve as surface mounting surfaces.

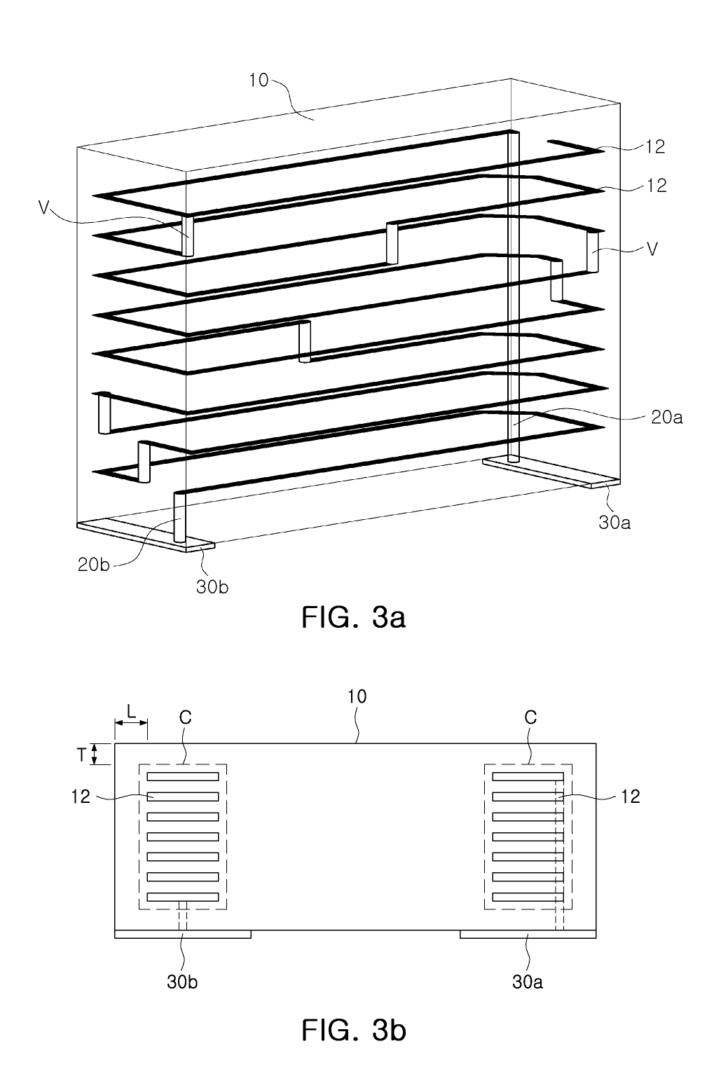

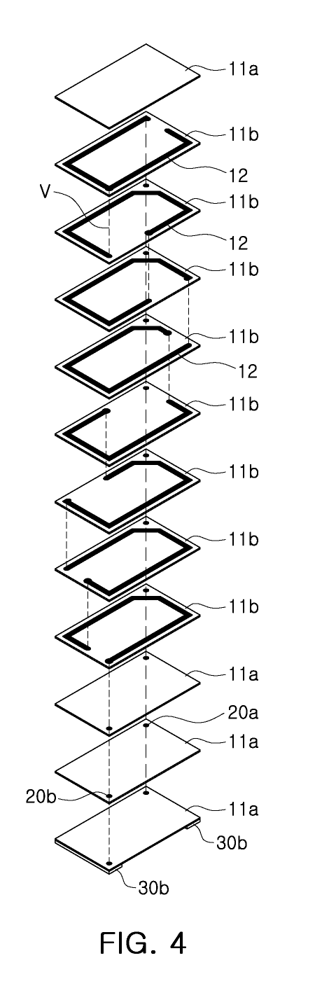

FIGS. 3a and 3b are a schematic perspective view and a sectional view of a multilayer type inductor according to another exemplary embodiment of the present invention, and FIG. 4 is an exploded perspective view of the multilayer type inductor illustrated in FIGS. 3a and 3b. Different elements from those of the exemplary embodiment as described above will be described, and a detailed description of the same elements will be omitted.

With reference to FIGS. 3a, 3b, and 4, a multilayer type inductor according to the present exemplary embodiment includes an inductor main body 10 including a plurality of sheets laminated therein, and first and second external terminals 30a and 30b formed on one surface of the inductor main body 10.

The conductive patterns 12 formed on the respective sheets are connected by the conductive via (V) to form the winding coil part (C).

Both ends of the coil part (C) are withdrawn to the exterior by first and second withdrawal vias 20a and 20b so as to be electrically connected to first and second external terminals 30a and 30b.

The first withdrawal via 20a formed at one end of the coil part (C), passing through the inductor main body 10, is formed at an outer side of the coil part (C), and withdrawn to one surface of the inductor body. In this case, the shape of the conductive patterns 12 may be appropriately changed to form the first withdrawal via 20a.

The second withdrawal via 20b formed at the other end of the coil part (C), is withdrawn in the same direction as that of the first withdrawal via 20a. Accordingly, the first and second external terminals 30a and 30b can be formed on the same plane of the inductor main body 10 and electrically connected to the first and second withdrawal vias 20a and 20b.

In the present exemplary embodiment, the first and second withdrawal vias 20a and 20b may be withdrawn in the mutually diagonal directions with respect to the outermost sheet 11a.

In the present exemplary embodiment, the first and second withdrawal vias 20a and 20b are withdrawn in the winding direction of the coil part (C). However, the present invention is not limited thereto, and the first and second withdrawal vias 20a and 20b may be withdrawn in a direction perpendicular to the winding direction of the coil part (C), namely, from the side surface of the inductor main body 10. In this case, in order for the first and second withdrawal vias 20a and 20b to be withdrawn in the direction perpendicular to the winding direction of the coil part (C), the shape of the first and second withdrawal vias 20a and 20b can be suitably changed. Namely, the first and second withdrawal vias 20a and 20b may be bent in the direction perpendicular to the winding direction of the coil part (C). In this case, the side surface of the inductor main body may serve as a surface mounting surface.

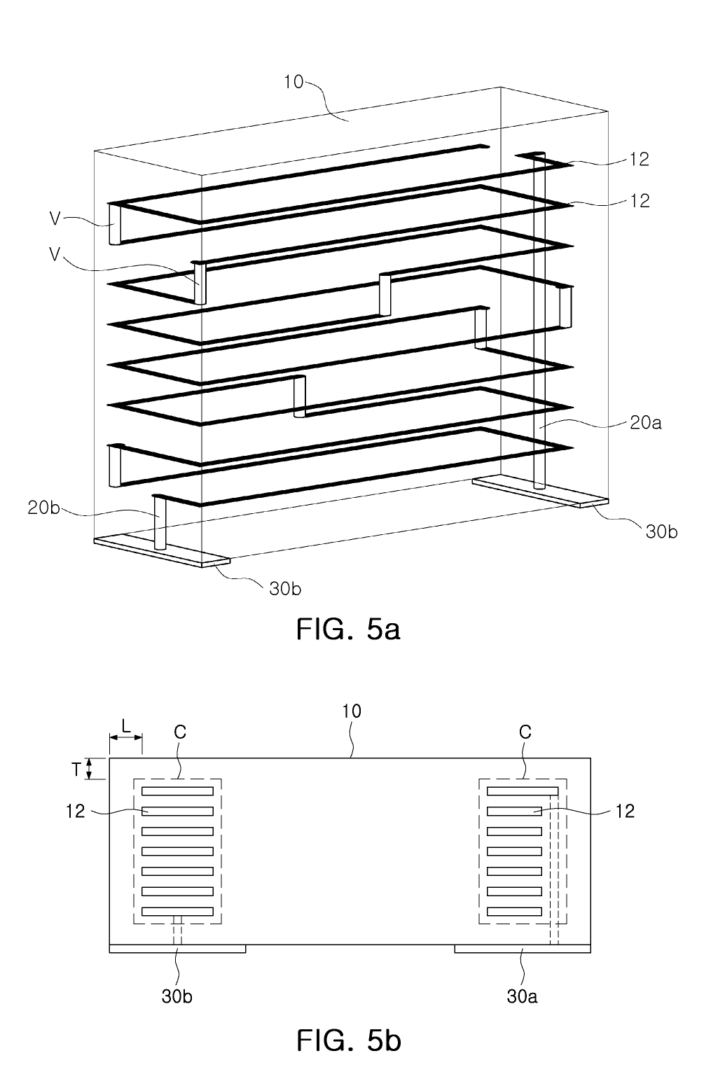

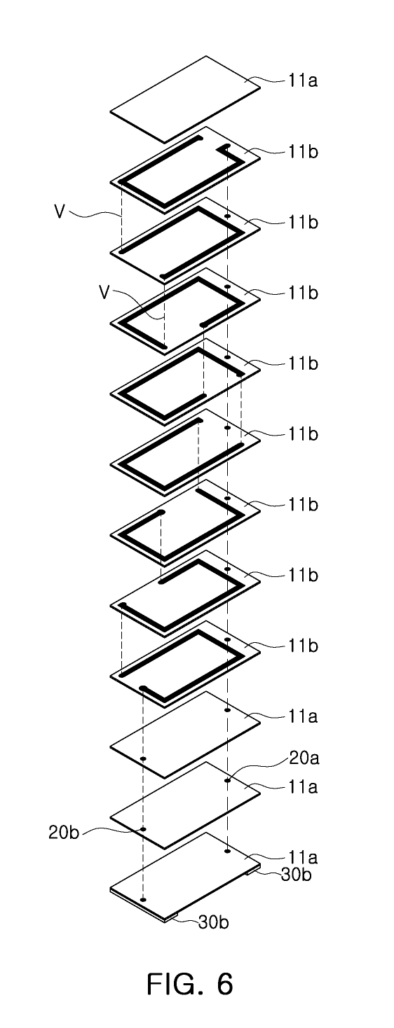

FIGS. 5a and 5b are schematic perspective view and sectional view of a multilayer type inductor according to another exemplary embodiment of the present invention, and FIG. 6 is an exploded perspective view of the multilayer type inductor illustrated in FIGS. 5a and 5b.

With reference to FIGS. 5a, 5b, and 6, a multilayer type inductor according to the present exemplary embodiment includes an inductor main body 10 including a plurality of sheets laminated therein, and first and second external terminals 30a and 30b formed on the same surface of the inductor main body 10.

The conductive patterns 12 formed on the respective sheets are connected by the conductive via (V) to form the winding coil part (C).

Both ends of the coil part (C) are withdrawn to the exterior by first and second withdrawal vias 20a and 20b so as to be electrically connected to first and second external terminals 30a and 30b.

The first withdrawal via 20a formed at one end of the coil part (C), passing through the inductor main body 10, is formed at an outer side of the coil part (C), and withdrawn to one surface of the inductor body.

The second withdrawal via 20b formed at the other end of the coil part (C), is withdrawn in the same direction as that of the first withdrawal via 20a. That is, the second external terminal 30b is withdrawn to the same surface from which the first withdrawal via 20a is withdrawn. Accordingly, the first and second external terminals 30a and 30b can be formed on the same plane of the inductor main body 10 and electrically connected to the first and second withdrawal vias 20a and 20b.

In the present exemplary embodiment, the first and second withdrawal vias 20a and 20b are withdrawn in mutually linear directions with respect to the outermost sheet 11a. In this case, the shape of the conductive patterns 12 may be appropriately changed to form the first withdrawal via 20a.

As set forth above, in the multilayer type inductor according to exemplary embodiments of the invention, because there is no external terminal on the upper surface of the inductor main body, the thickness (T) of the cover layer can be increased, and accordingly, DC overlap characteristics can be reduced.

Also, because there is no external terminal on the upper surface of the inductor main body, the thickness (L) of the side of the inductor main body can be secured, and also because the internal area of the coil part increases, an inductance value can be increased.

In addition, surface mounting can be easily performed by the first and second external terminals formed on the same plane of the inductor main body.

While the present invention has been shown and described in connection with the exemplary embodiments, it will be apparent to those skilled in the art that modifications and variations can be made without departing from the spirit and scope of the invention as defined by the appended claims.

What is claimed is:

1. A multilayer type inductor comprising:
an inductor main body 10 comprising a plurality of sheets laminated therein;
a coil part including conductive patterns and conductive vias formed on the respective sheets;
a first withdrawal via formed at one end of the coil part and withdrawn to one surface of the inductor main body through the inductor main body;
a second withdrawal via formed at the other end of the coil part and withdrawn in the same direction as that of the first withdrawal via; and
first and second external terminals formed on one surface of the inductor main body and electrically connected to the first and second withdrawal vias.

2. The multilayer type inductor of claim 1, wherein the first withdrawal via is formed at an inner side of the coil part.

3. The multilayer type inductor of claim 1, wherein the first withdrawal via is formed at an outer side of the coil part.

4. The multilayer type inductor of claim 1, wherein the plurality of sheets comprises a magnetic body.

5. The multilayer type inductor of claim 1, wherein the plurality of sheets comprises a dielectric body.

6. The multilayer type inductor of claim 1, wherein the first and second withdrawal vias are withdrawn in a winding direction of the coil part.

7. The multilayer type inductor of claim 1, wherein the first and second withdrawal vias are withdrawn in a direction perpendicular to the winding direction of the coil part.

8. The multilayer type inductor of claim 1, wherein the first and second withdrawal vias are withdrawn in mutually diagonal directions with respect to one surface of the inductor main body.

9. The multilayer type inductor of claim 1, wherein the first and second withdrawal vias are withdrawn in mutually linear directions with respect to one surface of the inductor main body.

10. The multilayer type inductor of claim 1, wherein the first withdrawal via is electrically connected to the first external terminal by a bridge electrode.

11. The multilayer type inductor of claim 1, wherein the conductive via and the first and second withdrawal vias comprise silver (Ag), silver-palladium (Ag—Pd), nickel (Ni), or copper (Cu).
